(19) United States
(12) Patent Application Publication
(10) Pub. No.: US 2026/0155586 A1
(43) Pub. Date: Jun. 4, 2026

(54) SYSTEMS AND METHODS OF GAP CONTROL FOR QUALITY BUSBAR WELDS

(71) Applicant: GM Global Technology Operations LLC, Detroit, MI (US)

(72) Inventors: Hui-ping Wang, Troy, MI (US); Guangze Li, Novi, MI (US); Eric Gregory Hartnagle, Rochester Hills, MI (US); Alexander Mepham, Auburn Hills, MI (US); Christopher Warmack, Goodrich, MI (US); Lu Huang, Troy, MI (US); Blair E. Carlson, Ann Arbor, MI (US)

(73) Assignee: GM Global Technology Operations LLC, Detroit, MI (US)

(21) Appl. No.: 18/968,458

(22) Filed: Dec. 4, 2024

(51) Int. Cl. H01R 4/02; B23K 26/21; H01R 43/02

(52) U.S. Cl. CPC H01R 4/029; B23K 26/21; H01R 43/0221

(57) ABSTRACT

A system including a busbar having a top surface and a bottom surface opposite the top surface, a terminal including a top surface and a bottom surface opposite the top surface, two or more welds applied to one of the top surface of the terminal or the bottom surface of the busbar, the two or more welds extending to a height between 0.1 mm and 0.2 mm and being configured to maintain a gap of between 0.1 mm and 0.2 mm in the subsequent welding area between the bottom surface of the busbar and the top surface of the terminal when the bottom surface of the busbar is mated with the top surface of the terminal, and one or more welds applied to the busbar and the terminal to secure the busbar to the terminal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to systems and methods of gap control for quality busbar welds. Porosity formation is a common issue in aluminum busbar welding, primarily due to the presence of low boiling point substances such as surface contaminants. When welding is performed under zero-gap conditions, vapor generated from the low boiling point substance becomes trapped, leading to the formation of pores in the weld. However, the vapor is able to freely escape by introducing a small gap of approximately 0.1-0.2 mm. The welding process becomes more stable and metallurgical pores in the weld are greatly reduced, leading to increased weld strength with more consistency.

### SUMMARY

This section provides a general summary of the means and methods associated with the disclosure and is not a comprehensive disclosure of its full scope or all its features.

One aspect of the disclosure provides a system including a busbar including a top surface and a bottom surface opposite the top surface, a terminal including a top surface and a bottom surface opposite the top surface, the terminal including a first weld applied to the top surface of the terminal that extends beyond the top surface of the terminal to a height between 0.1 mm and 0.2 mm and a second weld applied to the top surface of the terminal that extends beyond the top surface of the terminal to a height between 0.1 mm and 0.2 mm, the first weld and the second weld being configured to maintain a gap of between 0.1 mm and 0.2 mm in the area of subsequent welding between the bottom surface of the busbar and the top surface of the terminal when the bottom surface of the busbar is mated with the top surface of the terminal, and one or more welds applied to the busbar and the terminal to secure the busbar to the terminal.

Implementations of the disclosure may include one or more of the following optional features. In some implementations, the first weld and the second weld are stitch welds in straight lines or curves.

The first weld and the second weld may be spot welds.

The system may include a third weld applied to the top surface of the terminal that extends beyond the top surface of the terminal to a height between 0.1 mm and 0.2 mm and a fourth weld applied to the top surface of the terminal that extends beyond the top surface of the terminal to a height between 0.1 mm and 0.2 mm. The third weld and the fourth weld may be spot welds.

The height of the first weld and the height of the second weld may be based on the power applied by a laser weld machine.

The first weld and the second weld may be applied to the terminal during laser cutting of the terminal.

The first weld and the second weld may be applied to the terminal right before the terminal is welded to the busbar.

Another aspect of the disclosure provides a system including a busbar including a top surface and a bottom surface opposite the top surface, a terminal including a top surface and a bottom surface opposite the top surface, two or more welds applied to one of the top surface of the terminal or the bottom surface of the busbar, the two or more welds extending to a height between 0.1 mm and 0.2 mm and being configured to maintain a gap of between 0.1 mm and 0.2 mm in the subsequent welding area between the bottom surface of the busbar and the top surface of the terminal when the bottom surface of the busbar is mated with the top surface of the terminal, and one or more welds applied to the busbar and the terminal to secure the busbar to the terminal.

Implementations of the disclosure may include one or more of the following optional features. In some implementations, the two or more welds are stitch welds of straight lines or curves.

The two or more welds may be spot welds.

The two or more welds include four welds.

The height of the two or more welds may be based on the power applied by a laser weld machine.

The two or more welds may be applied to one of the terminal or the busbar during laser cutting of the terminal or busbar.

The two or more welds may be applied to one of the terminal or the busbar right before the terminal is welded to the busbar.

Another aspect of the disclosure provides a method including providing a busbar including a top surface and a bottom surface opposite the top surface, providing a terminal including a top surface and a bottom surface opposite the top surface, applying two or more welds to one of the top surface of the terminal or the bottom surface of the busbar, the two or more welds extending to a height between 0.1 mm and 0.2 mm and being configured to maintain a gap of between 0.1 mm and 0.2 mm between the bottom surface of the busbar and the top surface of the terminal when the bottom surface of the busbar is mated with the top surface of the terminal, and applying one or more welds to the busbar and the terminal to secure the busbar to the terminal.

Implementations of the disclosure may include one or more of the following optional features. In some implementations, the two or more welds are stitch welds of straight lines or curves.

The two or more welds may be spot welds.

The two or more welds may include four welds.

The height of the two or more welds may be based on the power applied by a laser weld machine.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected configurations and are not intended to limit the scope of the present disclosure.

FIG. 1 is a perspective view of a busbar and a terminal including pre-treated laser weld stitches in accordance with principles of the present disclosure;

FIG. 2 is a cross-sectional view of the terminal of FIG. 1 including the pre-treated laser weld stitches;

FIG. 3 is a cross-sectional view of the busbar of FIG. 1 welded to the terminal while maintaining a gap defined by the pre-treated laser weld stitches;

FIG. 4 is a perspective view of another terminal including pre-treated laser weld spots;

FIG. 5 is a perspective view of another terminal including pre-treated laser weld spots;

FIG. 6 is a perspective view of a busbar including pre-treated laser weld stitches and a terminal;

FIG. 7 is a cross-sectional view of the busbar of FIG. 6 with the pre-treated laser weld stitches adjacent the terminal while maintaining a gap defined by the pre-treated laser weld stitches;

FIG. 8A is a perspective view of a busbar including protrusions;

FIG. 8B is a cross-sectional view of the busbar of FIG. 8A including the protrusions;

FIG. 9 is a cross-sectional view of the busbar of FIG. 8A including the protrusions welded to the terminal while maintaining a gap defined by the protrusions;

FIG. 10 is a graph illustrating the strength of the weld between the terminal and busbar compared to nominal gap defined by the pre-treated laser weld stitches or protrusions; and

FIG. 11 is a graph illustrating the height of the laser weld stitches compared to power of the laser.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

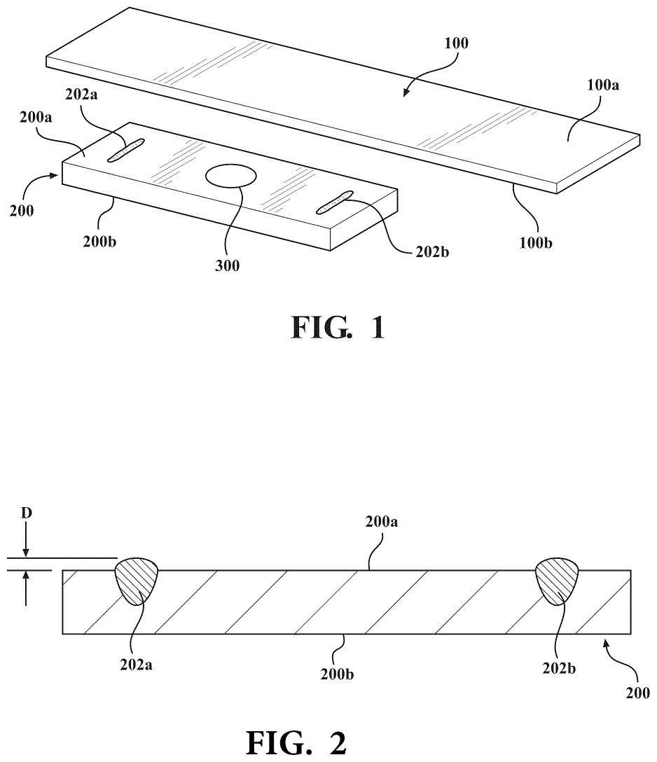

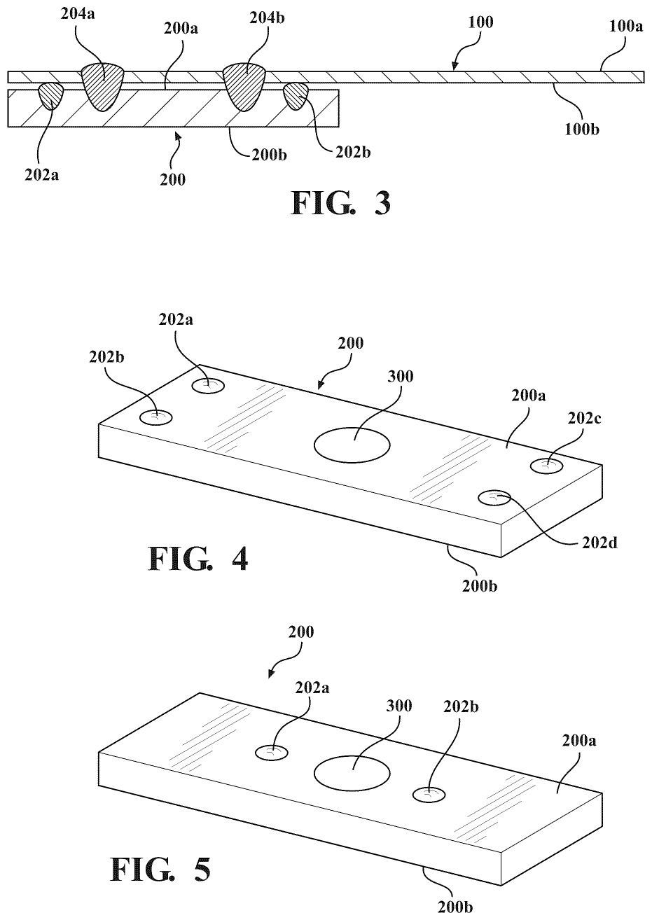

Referring to FIG. 1, a busbar 100 and terminal 200 are generally shown. The busbar 100 and terminal 200 are configured to be welded to one another for any suitable application, including, but not limited to, any suitable electrical application. The terminal 200 may include a contact portion 300 for transmitting electrical power or signals from the electrical source. The busbar 100 may include a top surface 100a and a bottom surface 100b. The busbar 100 may have any suitable size and shape. The terminal 200 may include a top surface 200a and a bottom surface 200b. The terminal 200 may have any suitable size and shape.

The terminal 200 may include one or more laser weld stitches 202a, 202b on the top surface 200a. The laser weld stitches 202a, 202b may be applied before joining the terminal 200 to the busbar 100. In some implementations, the laser weld stitches 202a, 202b may be formed using a laser beam while laser cutting the terminal 200 and busbar 100. In other implementations, the laser weld stitches 202a, 202b may be formed just before welding the busbar 100 and terminal 200 together. The laser weld stitches 202a, 202b can be straight or curved lines and may create a convex weld top surface being 0.1 mm-0.2 mm above the top surface 200a of the terminal 200. In this manner, when the busbar 100 is mated with the terminal 200, the laser weld stitches 202a, 202b maintain a gap D (as shown in FIG. 2) of 0.1 mm-0.2 mm between the top surface 200a of the terminal 200 and the bottom surface 100b of the busbar 100.

With the gap D maintained, the busbar 100 may be welded to the terminal 100 via welds 204a, 204b. Because of the gap D, vapor generated from a low boiling point substance is able to freely escape, resulting in the welding process becoming more stable and metallurgical pores in the weld being greatly reduced, thereby leading to increased weld strength with more consistency.

The laser weld stitches 202a, 202b may also be applied as one or more spot welds 202a, 202b, 202c, 202d in any suitable location. For example, FIG. 4 illustrates four spot welds 202a, 202b, 202c, 202d at the four corners of the terminal 200. As another example, FIG. 5 illustrates two spot welds 202a, 202b on either side of the contact portion 300. The spot welds may be any suitable size and shape, such as circular, square, amorphous, etc.

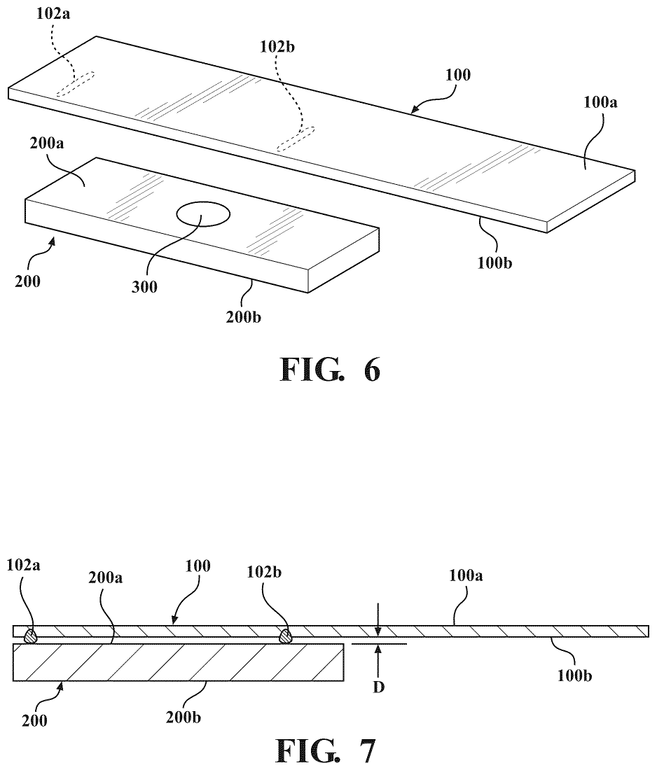

Referring to FIGS. 6 and 7, the busbar 100 may instead be pre-treated with the laser stitch welds 102a, 102b that create a convex weld bottom surface being 0.1 mm-0.2 mm below the bottom surface 100b of the busbar 100. In this manner, when the busbar 100 is mated with the terminal 200, the laser weld stitches 102a, 102b maintain a gap D (as shown in FIG. 7) of 0.1 mm-0.2 mm between the top surface 200a of the terminal 200 and the bottom surface 100b of the busbar 100.

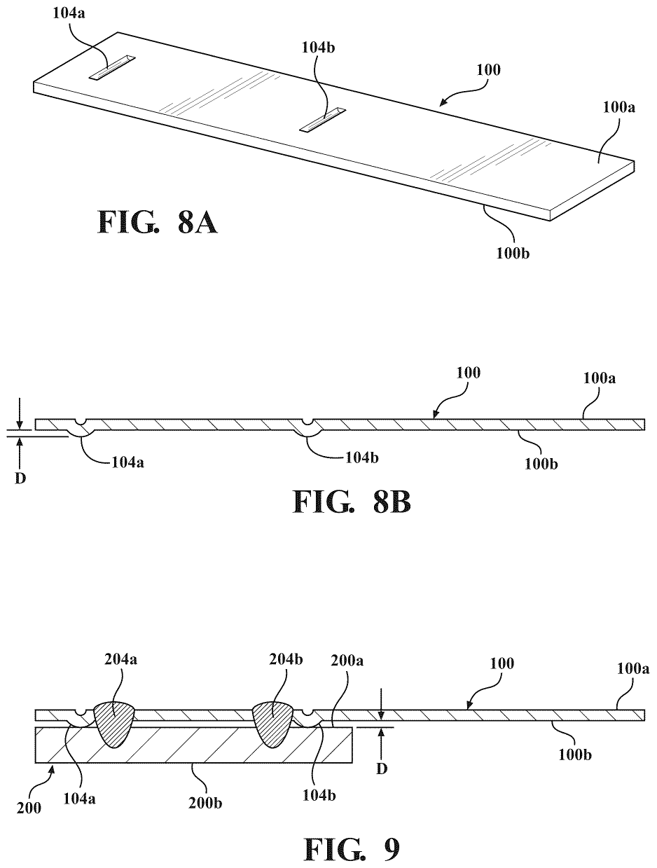

Referring to FIGS. 8A and 8B, the busbar 100 may include protrusions 104a, 104b protruding from the bottom surface 100b formed by stamping, hammering, or beading the top surface 100a to form an indentation in the top surface 100a and a corresponding protrusion at the bottom surface 100b. As shown in FIG. 9, the protrusions 104a, 104b maintain a gap D of 0.1 mm-0.2 mm between the top surface 200a of the terminal 200 and the bottom surface 100b of the busbar 100. The protrusions 104a, 104b may be any suitable shape, such as linear, circular, amorphous, etc. In some implementations, one or more shims may be installed between the busbar 100 and the terminal 200 to maintain the gap of between 0.1 mm and 0.2 mm.

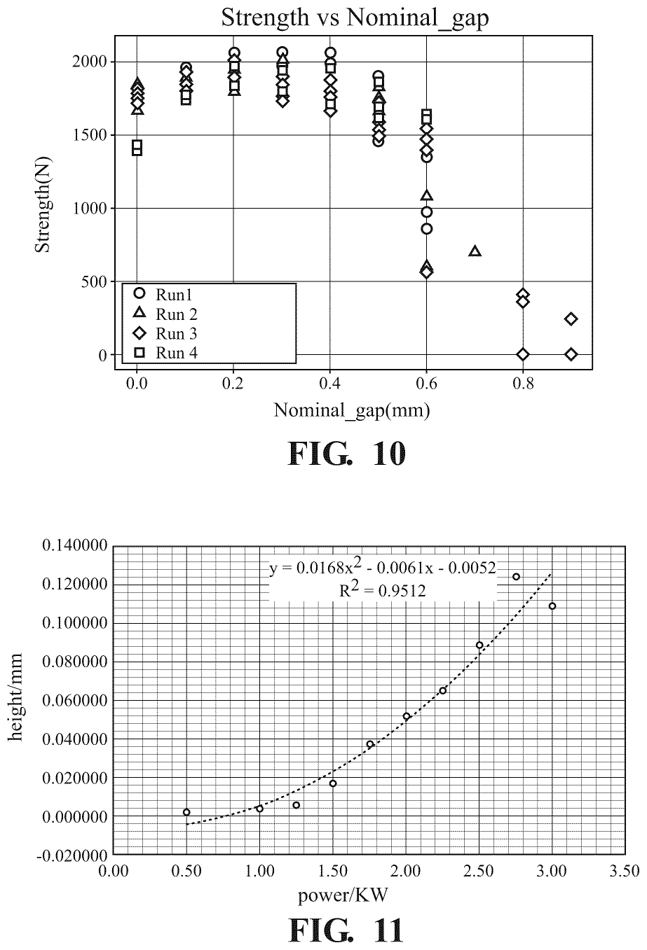

Referring to FIG. 10, the strength of the weld between the busbar 100 and the terminal 200 is shown at various gap distances between the busbar 100 and terminal 200. The data was collected across four different runs. As shown in the graph, the strength is highest between 0.1 mm and 0.2 mm.

Referring to FIG. 11, the power required by the laser weld machine to generate a weld with a specific height is shown. As set forth herein, the target height of the welds is between 0.1 mm and 0.2 mm. The data shown in FIG. 11 is also illustrated in Table 1 below.

TABLE 1

| Laser Power (KW) | Weld Height (mm) |
|---|---|
| 0.50 | 0.001872 |
| 1.00 | 0.003880 |
| 1.25 | 0.005564 |
| 1.50 | 0.016737 |
| 1.75 | 0.037342 |
| 2.00 | 0.051975 |
| 2.25 | 0.065113 |
| 2.50 | 0.088884 |
| 2.75 | 0.124502 |
| 3.00 | 0.108949 |

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system comprising:
a busbar including a top surface and a bottom surface opposite the top surface;
a terminal including a top surface and a bottom surface opposite the top surface of the terminal, the terminal including a first weld applied to the top surface of the terminal that extends beyond the top surface of the terminal to a height between 0.1 mm and 0.2 mm and a second weld applied to the top surface of the terminal that extends beyond the top surface of the terminal to a height between 0.1 mm and 0.2 mm, the first weld and the second weld being configured to maintain a gap of between 0.1 mm and 0.2 mm in the area of subsequent welding between the bottom surface of the busbar and the top surface of the terminal when the bottom surface of the busbar is mated with the top surface of the terminal; and
one or more welds applied to the busbar and the terminal to secure the busbar to the terminal.

2. The system of claim 1, wherein the first weld and the second weld are stitch welds in straight lines or curves.

3. The system of claim 1, wherein the first weld and the second weld are spot welds.

4. The system of claim 1, further comprising a third weld applied to the top surface of the terminal that extends beyond the top surface of the terminal to a height between 0.1 mm and 0.2 mm and a fourth weld applied to the top surface of the terminal that extends beyond the top surface of the terminal to a height between 0.1 mm and 0.2 mm.

5. The system of claim 4, wherein the third weld and the fourth weld are spot welds.

6. The system of claim 1, wherein the height of the first weld and the height of the second weld are based on the power applied by a laser weld machine.

7. The system of claim 1, wherein the first weld and the second weld are applied to the terminal during laser cutting of the terminal.

8. The system of claim 1, wherein the first weld and the second weld are applied to the terminal right before the terminal is welded to the busbar.

9. A system comprising:
a busbar including a top surface and a bottom surface opposite the top surface;
a terminal including a top surface and a bottom surface opposite the top surface of the terminal;
two or more welds applied to one of the top surface of the terminal or the bottom surface of the busbar, the two or more welds extending to a height between 0.1 mm and 0.2 mm and being configured to maintain a gap of between 0.1 mm and 0.2 mm in the subsequent welding area between the bottom surface of the busbar and the top surface of the terminal when the bottom surface of the busbar is mated with the top surface of the terminal; and
one or more welds applied to the busbar and the terminal to secure the busbar to the terminal.

10. The system of claim 9, wherein the two or more welds are stitch welds of straight lines or curves.

11. The system of claim 9, wherein the two or more welds are spot welds.

12. The system of claim 9, wherein the two or more welds include four welds.

13. The system of claim 9, wherein the height of the two or more welds are based on the power applied by a laser weld machine.

14. The system of claim 9, wherein the two or more welds are applied to one of the terminal or the busbar during laser cutting of the terminal or busbar.

15. The system of claim 9, wherein the two or more welds are applied to one of the terminal or the busbar right before the terminal is welded to the busbar.

16. A method comprising:
providing a busbar including a top surface and a bottom surface opposite the top surface;
providing a terminal including a top surface and a bottom surface opposite the top surface of the terminal;
applying two or more welds to one of the top surface of the terminal or the bottom surface of the busbar, the two or more welds extending to a height between 0.1 mm and 0.2 mm and being configured to maintain a gap of between 0.1 mm and 0.2 mm between the bottom surface of the busbar and the top surface of the terminal when the bottom surface of the busbar is mated with the top surface of the terminal; and
applying one or more welds to the busbar and the terminal to secure the busbar to the terminal.

17. The method of claim 16, wherein the two or more welds are stitch welds of straight lines or curves.

18. The method of claim 16, wherein the two or more welds are spot welds.

19. The method of claim 16, wherein the two or more welds include four welds.

20. The method of claim 16, wherein the height of the two or more welds are based on the power applied by a laser weld machine.
